(19) United States
(12) Patent Application Publication
(10) Pub. No.: US 2007/0115930 A1
(43) Pub. Date: May 24, 2007

(54) Method and system for advanced voice over internet protocol (VoIP) emergency notification

(75) Inventors: Douglas F. Reynolds, Austin, TX (US); Aaron Bangor, Austin, TX (US); Jeffrey L. Brandt, Cedar Park, TX (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/282,134

(22) Filed: Nov. 18, 2005

(51) Int. Cl. H04L 12/66

(52) U.S. Cl. 370/352

(57) ABSTRACT

An emergency system for advanced Voice over Internet Protocol (VoIP) emergency notification combines the utility of an alarm system with the flexibility of a VoIP telephone network to aid emergency authorities and those in need during an emergency within a locale such as a building. The alarm system and/or security personnel take control of the VoIP network in response to an emergency to notify the building users of the emergency. A VoIP call manager recognizes that a VoIP emergency call (such as a “911” call) has been placed through the VoIP network to the emergency authorities by either the alarm system or the security personnel and then routes another emergency call, in either interactive or audio-only mode, to onsite personnel and other parties interested in the emergency. The emergency call serves as a notification for its recipients to coordinate with the emergency authorities.

### BACKGROUND OF THE INVENTION

1. Field of the Disclosure

The present disclosure generally relates to emergency alarm systems and Voice over Internet Protocol (VoIP) communications networks.

2. Background Art

Voice over Internet Protocol (VoIP) communications is replacing circuit switch-based communications. A characteristic associated with VoIP communications is its simplicity with routing calls and information. VoIP communications enables flexibility that is not readily available to individuals and businesses using circuit switch-based communications. As such, it is desirable to adapt useful features to VoIP communications networks.

### BRIEF DESCRIPTION OF THE DRAWINGS

The present disclosure is pointed out with particularity in the appended claims. However, other features of the present disclosure will become more apparent and the present disclosure will be best understood by referring to the following detailed description in conjunction with the accompanying drawings in which:

FIG. 1 illustrates a block diagram of an emergency system in accordance with the present disclosure;

FIG. 2 illustrates a flowchart describing operation of the emergency system in accordance with the present disclosure; and

FIG. 3 illustrates a diagrammatical representation of a machine in the form of a computer system within which a set of instructions, when executed, causes the machine to perform any one or more of the methodologies in accordance with the present disclosure.

### DETAILED DESCRIPTION OF THE PREFERRED EMBODIMENT(S)

The present disclosure discloses a system for advanced Voice over Internet Protocol (VoIP) notification of an emergency in a building having a VoIP network and further having an alarm system for detecting emergencies in the building. The system includes a VoIP call management device in communication with the alarm system for being alerted to an emergency detected by the alarm system. In response to being alerted by the alarm system to an emergency in the building the VoIP call management device places a VoIP emergency call via the VoIP network to a VoIP telephone of an emergency authority user located outside of the building and the VoIP call management device places another VoIP emergency call via the VoIP network to a VoIP telephone of a non-emergency authority user located outside of the building who is to be notified of the emergency. In response to being alerted by the alarm system to an emergency in the building the VoIP call management device may further communicate a notification via the VoIP network to VoIP telephones located inside the building in order to alert users of the building to the emergency.

The present disclosure discloses a system for advanced VoIP notification of an emergency. This system includes a VoIP network associated with a building. The VoIP network has a VoIP call management device. The VoIP network further has VoIP telephones for use by building users located within the building. The VoIP network is connected to an Internet Protocol (IP) network connected to VoIP telephones for use by users located outside of the building such that the VoIP telephones for use by the building users and the users located outside of the building are connected in order for these users to communicate VoIP telephone calls to one another. This system further includes an alarm system for detecting an emergency in the building. The alarm system is in communication with the VoIP call management device. In response to detecting an emergency in the building, the alarm system directs the VoIP call management device to have the VoIP network place a VoIP emergency call to the VoIP telephone of an emergency authority user located outside of the building. In response to the VoIP network placing the VoIP emergency call to the VoIP telephone of the emergency authority user, the VoIP call management device has the VoIP network place another VoIP emergency call to the VoIP telephones of non-emergency authority users located outside of the building who are to be notified of the emergency. In response to detecting an emergency in the building, the alarm system may further direct the VoIP call management device to communicate a notification to the VoIP telephones for use by the building users in order to alert the building users of the emergency.

The present disclosure discloses a method for advanced VoIP notification of an emergency. The method includes using an alarm system to detect for emergencies in a building. In response to the alarm system detecting an emergency in the building, a VoIP emergency call is placed from a VoIP telephone of a VoIP network associated with the building to a VoIP telephone of an emergency authority located outside of the building. In response to the VoIP emergency call being placed to the VoIP telephone of the emergency authority user, another VoIP emergency call is placed to the VoIP telephones of non-emergency authority users located outside of the building who are to be notified of the emergency. In response to the alarm system detecting an emergency in the building, a notification may be communicated to VoIP telephones of the VoIP network associated with the building for alerting users of the building to the emergency.

The present disclosure discloses a computer-readable medium for advanced VoIP notification of an emergency. The medium includes instructions for using an alarm system to detect for emergencies in a building. The medium further includes instructions for placing a VoIP emergency call from a VoIP telephone of a VoIP network associated with the building to a VoIP telephone of an emergency authority located outside of the building in response to an emergency in the building being detected. The medium further includes instructions for placing another VoIP emergency call to the VoIP telephones of non-emergency authority users located outside of the building who are to be notified of the emergency in response to the VoIP emergency call being placed to the VoIP telephone of the emergency authority user. The medium may further include instructions for communicating a notification to VoIP telephones of the VoIP network associated with the building for alerting users of the building to the emergency in response to the emergency being detected.

In general, the present disclosure provides a method and system for advanced Voice over Internet Protocol (VoIP) emergency notification. The method and system provide useful features to VoIP communications networks by readily aiding both emergency authorities and those in need during an emergency situation within a locale such as a building or a campus of buildings.

The method and system facilitate action and reaction during an emergency situation in a building(s) having a standard building alarm system and a VoIP telephone network by combining the utility of the alarm system with the flexibility of the VoIP network. The method and system enable the alarm system and/or building security personnel to take control of and use the VoIP network in order to provide emergency notification to the building users in the event of an emergency in the building.

The VoIP network includes VoIP telephones for the building users to place and receive VoIP telephone calls. The VoIP network is part of a larger VoIP communications network which enables VoIP telephone calls to be placed between the VoIP telephones within the building and VoIP telephones located outside of the building.

The method and system include two functional aspects. A first functional aspect is the building alarm system and/or building security personnel being able to take control of the VoIP network of the building in the event of an emergency in the building in order to provide emergency notification to the building users via their VoIP telephones. A second functional aspect is a VoIP call management device of the VoIP network recognizing that a VoIP emergency call (such as a “911” call) has been placed to offsite emergency authorities (either by the alarm system or the building security personnel) and then routing a duplication of the emergency call to onsite security/emergency personnel and/or other affected parties (e.g., family members of a building user affected by the emergency, the building's owner, etc.). The VoIP call management device routes the duplicate emergency call to any of these recipients in either interactive or audio-only mode. The duplicate emergency call serves as a notification for its recipients to prepare for the arrival of the emergency authorities. As such, the duplicate emergency call further serves for coordinating activities between the duplicate emergency call recipients and the emergency authorities depending on the nature of the emergency.

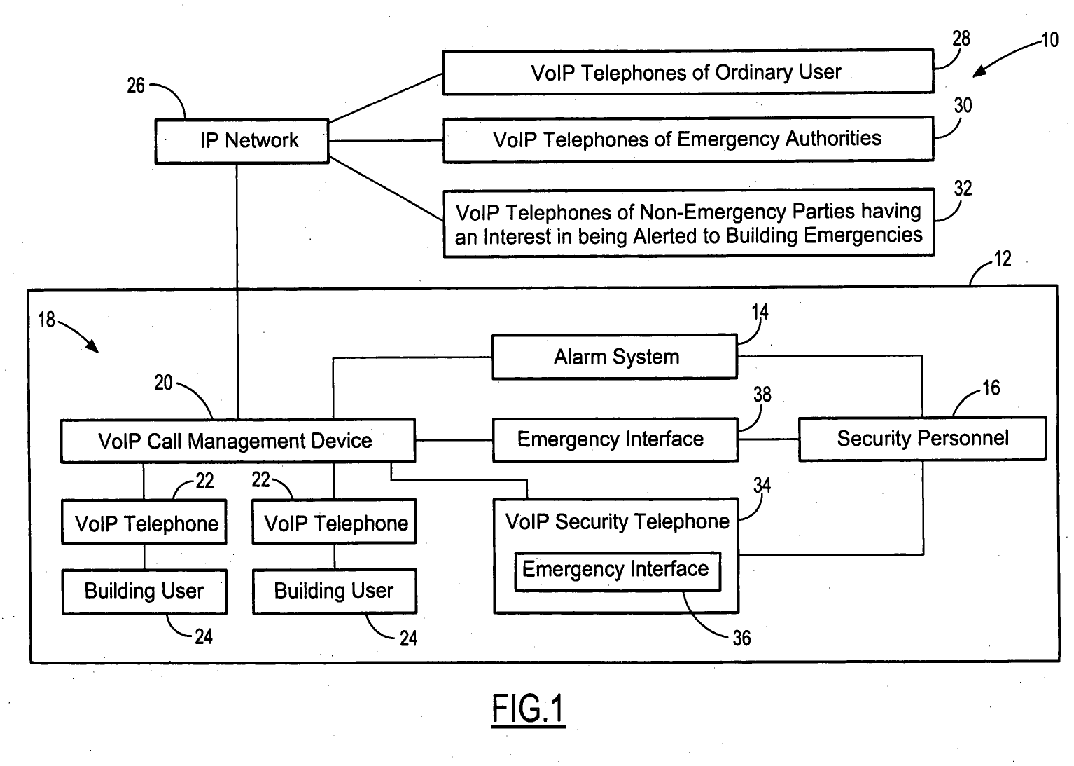

Referring now to FIG. 1, a block diagram of an emergency system 10 in accordance with the present disclosure is shown. Emergency system 10 is generally for use with a locale such as a building 12 or a campus of buildings. Emergency system 10 includes an alarm system 14 and a VoIP telephone network 18. Alarm system 14 and VoIP network 18 are located in and are associated with building 12.

Alarm system 14 provides typical alarm functions to monitor for emergency situations in building 12. Emergency situations monitored by alarm system 14 include unauthorized building intrusions, fires in the building, distress calls placed by building users, etc. Alarm system 14 is operable for providing relief in response to an emergency situation. For example, alarm system 14 triggers a building sprinkler system to sprinkle water in building 12 in response to detecting a fire. As another example, alarm system 14 triggers visual/audible alerts to notify the building users of an emergency in building 12 in response to detecting the emergency. As a further example, alarm system 14 notifies emergency authorities in response to detecting an emergency. To this end, as will be described in greater detail below, alarm system 14 is operable with VoIP network 18 to place a VoIP “911” emergency telephone call to outside emergency authorities such as a ”911” operator. Security personnel 16 of building 12 are in communication with alarm system 14 to be apprised of any emergency situation detected by the alarm system in order to be aware of and respond to the emergency.

VoIP network 18 includes a VoIP call management device 20 and a plurality of VoIP telephones 22. Building users 24 use VoIP telephones 22 to make VoIP telephone calls with other building users and with VoIP telephone users located outside of building 12. To this end, VoIP call management device 20 connects with an Internet Protocol (IP) network 26. IP network 26 is located outside of building 12 and connects with the VoIP telephones of VoIP telephone users outside of the building. As shown in FIG. 1, VoIP telephones outside of building 12 include VoIP telephones 28 of ordinary VoIP telephone users located outside of building 12, VoIP telephones 30 of emergency authorities including a “911” operator, and VoIP telephones 32 of individuals outside of the building that are to be notified of emergencies in the building (e.g., the owner of the building, physicians of building users, family members of building users, etc.).

VoIP network 18 further includes a VoIP telephone 34 for use by security personnel 16. In the same manner that building users 24 use their VoIP telephones 22 to make VoIP telephone calls with other VoIP telephone users inside and outside of building 12, security personnel 16 use VoIP telephone 34 to make VoIP telephone calls to other VoIP telephone users. For instance, security personnel 16 use VoIP telephone 34 to make VoIP telephone calls via VoIP network 18 to VoIP telephones 22 of building users 24. In response to detecting an emergency in building 12 and/or in response to being apprised of an emergency by alarm system 14, security personnel 16 use VoIP telephone 34 to place a VoIP “911” emergency telephone call via VoIP network 18 to VoIP telephone 30 of a “911” operator for receipt by emergency authorities (such as the fire and police departments). Similarly, alarm system 14 is in communication with VoIP call management device 20 to automatically place a VoIP “911” emergency telephone call via VoIP network 18 to VoIP telephone 30 of the “911” operator in response to detecting an emergency situation.

Emergency system 10 generally includes two functional aspects. A first functional aspect is the ability of alarm system 14 and/or security personnel 16 to take control of VoIP network 18 based on the nature of an emergency in building 12. A second functional aspect is the ability of VoIP call management device 20 to recognize that a VoIP “911” emergency telephone call has been placed to outside emergency authorities (either by alarm system 14 or security personnel 16) and then route a duplication of the emergency call to VoIP telephone 34 of security personnel 16 and/or to VoIP telephones 32 of parties having an interest in the emergency (e.g., family members of building users affected by the emergency, the building's owner, etc.).

With respect to the first functional aspect, alarm system 14 and/or security personnel 16 take control of the entire (or a subset of the entire) VoIP network 18 based on the nature of an emergency in building 12 in order to communicate with VoIP telephones 22 to provide an emergency notification to building users 24. More particularly, alarm system 14 and/or security personnel 16 interact with VoIP call management device 20 in order to have the VoIP call management device provide an emergency notification to building users 24 via VoIP telephones 22.

Several manifestations of the emergency notification exist. For example, VoIP call management device 20 rings VoIP telephones 22 of building users 24 in order to provide the emergency notification to the building users. As another example, VoIP call management device 20 places VoIP telephones 22 not currently involved in calls in a speaker phone mode to announce an emergency and give instructions (i.e., forming a public address system). As another example, VoIP call management device 20 breaks into ongoing calls being made by VoIP telephones 22 to provide the emergency notification to building users 24.

Alarm system 14 connects to VoIP call management device 20 in order to take control of VoIP network 18 and have the VoIP call management device provide an emergency notification to building users 24 via their VoIP telephones 22 in response to the alarm system detecting an emergency. Security personnel 16 have access to an emergency interface of VoIP network 18 in order to take control of the VoIP network and have VoIP call management device 20 provide an emergency notification to building users 24 via their VoIP telephones 22 in response to an emergency. For instance, VoIP telephone 34 of security personnel 16 includes an emergency interface 36. Emergency interface 36 is in communication with VoIP call management device 20 in order to enable security personnel 16 to interact with the VoIP call management device and take control of VoIP network 18 for providing the emergency notification to building users 24 via VoIP telephones 22. VoIP telephones 22 of building users 24 may also be configured with the emergency interface. The emergency interface may also be embodied as a web-based or standalone application on a computer 38 that is communicable with VoIP call management device 20.

As such, via an emergency interface of VoIP network 18, security personnel 16 notify affected building users 24 via their VoIP telephones 22 of an emergency and are able to give warnings/emergency instructions to affected building users in response to being apprised of the emergency. Likewise, alarm system 14 notifies affected building users 24 via their VoIP telephones 22 of an emergency and is able to give warnings/emergency instructions to affected building users in response to detecting the emergency. In the latter case, emergency system 10 is automated by a direct emergency interface between alarm system 14 and VoIP call management device 20 in order to reduce the load on security personnel 16 as well as to handle after-hours conditions where security personnel may not be present at building 12.

The type of warnings/emergency instructions provided by alarm system 14 and security personnel 16 may be predetermined based on different types of emergencies. As such, the emergency interface allows customized broadcasting ability based on either predefined emergency scenarios or scenarios chosen by security personnel 16 in order for quicker and more effective notification to building users 24.

With respect to the second functional aspect, VoIP call management device 20 recognizes that a VoIP “911” emergency telephone call has been placed to VoIP telephone 30 of emergency authorities (either by alarm system 14 or security personnel 16) and then routes a VoIP duplication of the emergency call to VoIP telephone 34 of security personnel 16 and/or to VoIP telephones 32 of parties interested in the emergency (e. g., family members of building users affected by the emergency, the building's owner, etc.). VoIP call management device 20 routes the duplicate VoIP emergency call to VoIP telephones 32, 34 in either interactive or audio-only mode. The duplicate emergency call serves as a notification for its recipients to prepare for the emergency authorities. As such, the duplicate emergency call further serves for coordinating activities between the duplicate emergency call recipients and the emergency authorities (such as fire and police authorities) depending on the nature of the emergency.

Accordingly, the second functional aspect allows for automatic recognition of a VoIP emergency telephone call placed by either alarm system 14 or security personnel 16 to VoIP call management device 20 for receipt by VoIP telephones 30 of emergency authorities (i.e., the “911” operator) via VoIP network 18. Upon recognition, VoIP call management device 20 routes the VoIP emergency call normally to VoIP telephone 30 of emergency authorities, but also routes. a duplication of the emergency call (i.e., a second VoIP emergency call) to a VoIP telephone 32 of each party having an interest in the emergency (as well as to VoIP telephone 34 of other security personnel in building 12 if desired). To this end, VoIP call management device 20 has a list of parties to be notified of emergencies in building 12 and the telephone numbers of their associated VoIP telephones 32, 34. VoIP call management device accesses this list and routes the second emergency call to VoIP telephone 32, 34 of each party to be notified of an emergency.

The list of interested parties may be correlated with different emergency types. As such, VoIP call management device 20 routes the second emergency call to only a subset of the interested parties on the list depending on the type of emergency. In addition to other security personnel of building 12, such interested parties include offsite security personnel, personal physicians, the building owner and operator, family members of building users, etc.

The duplicate emergency call to each interested party conferences the interested parties into the original VoIP emergency call placed to VoIP telephone 30 of emergency authorities. This conference call can either be audio-only to serve as notification or can be a live conference to allow for coordination and facilitation with emergency authorities.

A benefit of emergency system 10 includes increasing the utility of current emergency systems and adding improved ability for coordination among building security personnel, emergency authorities, and other interested parties.

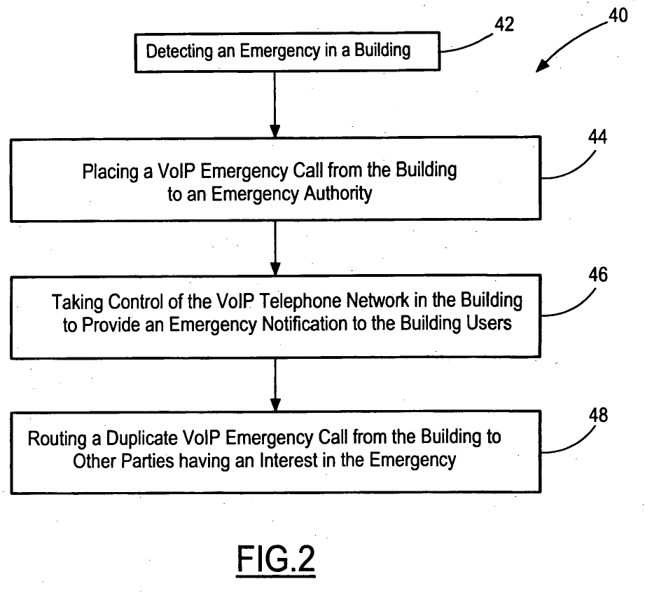

Referring now to FIG. 2, with continual reference to FIG. 1, a flowchart 40 describing operation of emergency system 10 is shown. The operation of emergency system 10 begins with alarm system 14 and/or security personnel 16 detecting an emergency in building 12 as shown in block 42. In response to the emergency, alarm system 14 (automatically) and/or security personnel 16 (manually) place a VoIP “911” emergency telephone call to VoIP telephone 30 of emergency authorities via VoIP network 18 as shown in block 44. In response to the emergency, alarm system 14 (automatically) and/or security personnel 16 (manually) take control of VoIP network 18 in order to provide emergency notification and instructions to building users 24 via VoIP telephones 22 as shown in block 46. VoIP call management device 20 recognizes that a VoIP “911” emergency telephone call has been placed to emergency authorities via VoIP network 18 and then routes a duplicate VoIP emergency call to VoIP telephones 32, 34 of other parties to be notified of the emergency as shown in block 48.

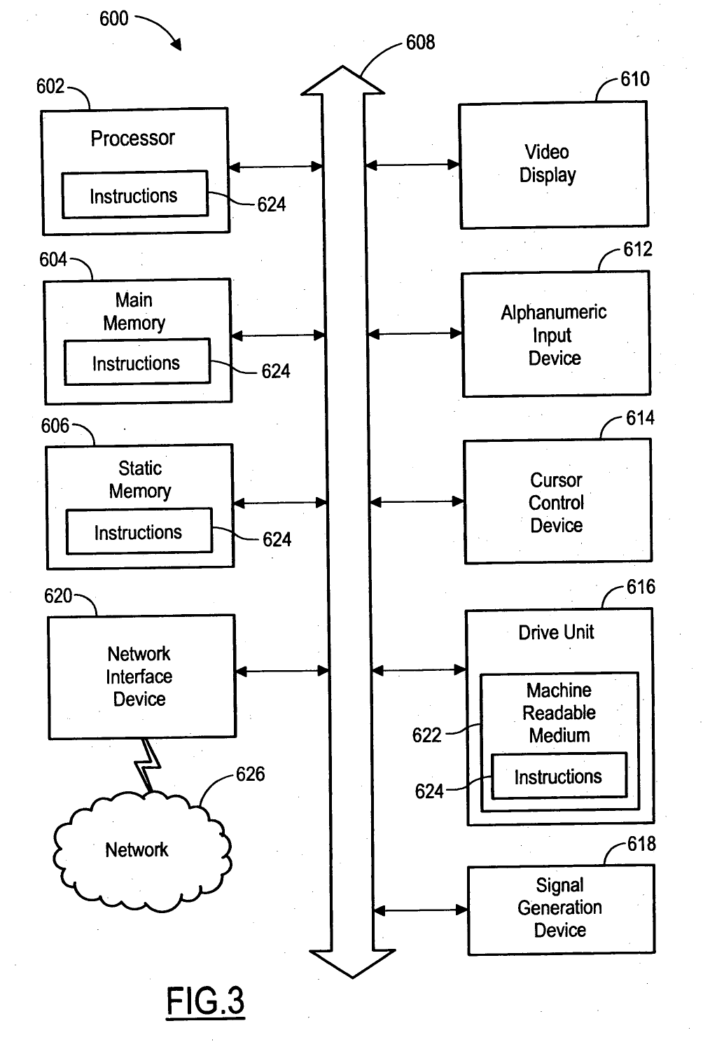

Referring now to FIG. 3, a diagrammatic representation of a machine in the form of a computer system 600 is shown within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may include a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

Computer system 600 may include a processor 602 (e.g., a central processing unit (CPU), a graphics processing unit (GPU), or both), a main memory 604 and a static memory 606, which communicate with each other via a bus 608. Computer system 600 may further include a video display unit 610 (e.g., a liquid crystal display (LCD), a flat panel, a solid state display, or a cathode ray tube (CRT)). Computer system 600 may include an input device 612 (e.g., a keyboard), a cursor control device 614 (e.g., a mouse), a disk drive unit 616, a signal generation device 618 (e.g., a speaker or remote control) and a network interface device 620.

Disk drive unit 616 may include a machine-readable medium 622 on which is stored one or more sets of instructions (e.g., software 624) embodying any one or more of the methodologies or functions described herein, including those methods illustrated in herein above. Instructions 624 may also reside, completely or at least partially, within main memory 604, static memory 606, and/or within processor 602 during execution thereof by computer system 600. Main memory 604 and processor 602 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using instructions 624. Instructions 624 may further be transmitted or received over a network 626 via network interface device 620.

While machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the present disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the present disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. The Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C. F. R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for advanced Voice over Internet Protocol (VoIP) notification of an emergency in a building having a VoIP network and further having an alarm system for detecting emergencies in the building, the system comprising:
a VoIP call management device in communication with the alarm system for being alerted to an emergency detected by the alarm system;
wherein in response to being alerted by the alarm system to an emergency in the building the VoIP call management device places a VoIP emergency call via the VoIP network to a VoIP telephone of an emergency authority user located outside of the building and the VoIP call management device places another VoIP emergency call via the VoIP network to a VoIP telephone of a non-emergency authority user located outside of the building who is to be notified of the emergency.

2. The system of claim 1 wherein:
in response to being alerted by the alarm system to an emergency in the building the VoIP call management device communicates a notification via the VoIP network to VoIP telephones located inside the building in order to alert users of the building to the emergency.

3. A system for advanced Voice over Internet Protocol (VoIP) notification of an emergency, the system comprising:
a VoIP network associated with a building, the VoIP network having a VoIP call management device, the VoIP network further having a plurality of VoIP telephones for use by building users located within the building, the VoIP network being connected to an IP network connected to VoIP telephones for use by users located outside of the building such that the VoIP telephones for use by the building users and the users located outside of the building are connected in order for these users to communicate VoIP telephone calls to one another; and
an alarm system for detecting an emergency in the building, the alarm system being in communication with the VoIP call management device;
wherein in response to detecting an emergency in the building, the alarm system directs the VoIP call management device to have the VoIP network place a VoIP emergency call to the VoIP telephone of an emergency authority user located outside of the building;
wherein in response to the VoIP network placing the VoIP emergency call to the VoIP telephone of the emergency authority user, the VoIP call management device has the VoIP network place another VoIP emergency call to the VoIP telephones of non-emergency authority users located outside of the building who are to be notified of the emergency.

4. The system of claim 3 wherein:
in response to detecting an emergency in the building, the alarm system directs the VoIP call management device to communicate a notification to the VoIP telephones for use by the building users in order to alert the building users of the emergency.

5. The system of claim 4 wherein:
the VoIP call management device communicates the notification to the VoIP telephones for use by the building users by ringing these VoIP telephones to announce the notification to the building users.

6. The system of claim 4 wherein:
the VoIP call management device communicates the notification to the VoIP telephones for use by the building users by placing these VoIP telephones in a speaker phone mode to announce the notification to the building users.

7. The system of claim 6 wherein:
the notification includes a customized broadcast based on predefined emergency scenarios depending on a type of the emergency as determined by the alarm system.

8. The system of claim 4 wherein:
the VoIP call management device communicates the notification to the VoIP telephones for use by the building users by breaking into current VoIP telephone calls made by these VoIP telephones to announce the notification to the building users.

9. The system of claim 3 wherein:
in response to detecting an emergency in the building, the alarm system determines a type of the emergency and then directs the VoIP call management device to communicate a notification, depending on the emergency type, to a subset of the VoIP telephones for use by a subset of the building users in order to alert these building users of the emergency.

10. The system of claim 3 wherein:
in response to the VoIP network placing the VoIP emergency call to the VoIP telephone of the emergency authority user, the VoIP call management device places the VoIP emergency call to the VoIP telephones of security personnel located within the building who are to be notified of the emergency.

11. The system of claim 3 wherein:
in response to detecting an emergency in the building, the alarm system determines a type of the emergency and provides an indicator regarding the type of the emergency to the VoIP call management device, wherein in response to the VoIP network placing the VoIP emergency call to the VoIP telephone of the emergency authority user, the VoIP call management device has the VoIP network place another VoIP emergency call to the VoIP telephones of the non-emergency authority users located outside of the building who are to be notified of the emergency depending on the type of the emergency.

12. The system of claim 3 wherein:
the VoIP network places the VoIP emergency call to the VoIP telephones of the non-emergency authority users in an interactive mode to conference the non-emergency authority users and the emergency authorities together such that these users are able to communicate with one another.

13. The system of claim 3 wherein:
the VoIP network places the VoIP emergency call to the VoIP telephones of the non-emergency authority users in an audio-only mode to conference the non-emergency authority users and the emergency authorities together such that the non-emergency authority users are able to hear the communications of the emergency authorities during the VoIP emergency call.

14. The system of claim 3 wherein:
the VoIP network further includes an emergency interface for access to the VoIP network by security personnel of the building;
wherein in response to the security personnel being alerted to an emergency in the building, the security personnel access the emergency interface to have the VoIP network place a VoIP emergency call to the VoIP telephone of an emergency authority user located outside of the building.

15. The system of claim 3 wherein:
the VoIP network further includes an emergency interface for access to the VoIP network by security personnel of the building;
wherein in response to the security personnel being alerted to an emergency in the building, the security personnel access the emergency interface to direct the VoIP call management device to communicate a notification to the VoIP telephones for use by the building users in order to alert the building users of the emergency.

16. A method for advanced Voice over Internet Protocol (VoIP) notification of an emergency, the method comprising:
using an alarm system to detect for emergencies in a building;
in response to the alarm system detecting an emergency in the building, placing a VoIP emergency call from a VoIP telephone of a VoIP network associated with the building to a VoIP telephone of an emergency authority located outside of the building;
in response to the VoIP emergency call being placed to the VoIP telephone of the emergency authority user, placing another VoIP emergency call to the VoIP telephones of non-emergency authority users located outside of the building who are to be notified of the emergency.

17. The method of claim 16 further comprising:
in response to the alarm system detecting an emergency in the building, communicating a notification to VoIP telephones of the VoIP network associated with the building for alerting users of the building to the emergency.

18. The method of claim 16 further comprising:
using the alarm system to determine a type of emergency detected by the alarm system;
in response to the alarm system detecting an emergency in the building, placing the VoIP emergency call to VoIP telephones of non-emergency authority users located outside of the building who are to be notified of the emergency depending on the type of the emergency.

19. The method of claim 16 wherein:
placing the VoIP emergency call to the VoIP telephones of non-emergency authority users located outside of the building who are to be notified of the emergency includes placing the VoIP emergency call in an interactive mode to conference the non-emergency authority users and the emergency authorities together such that these users are able to communicate with one another.

20. The method of claim 16 wherein:
placing the VoIP emergency call to the VoIP telephones of non-emergency authority users located outside of the building who are to be notified of the emergency includes placing the VoIP emergency call in an audio-only mode to conference the non-emergency authority users and the emergency authorities together such that the non-emergency authority users are able to hear the communications of the emergency authorities during the VoIP emergency call.

21. A computer-readable medium for advanced Voice over Internet Protocol (VoIP) notification of an emergency, the medium comprising:
instructions for using an alarm system to detect for emergencies in a building;
instructions for placing a VoIP emergency call from a VoIP telephone of a VoIP network associated with the building to a VoIP telephone of an emergency authority located outside of the building in response to an emergency in the building being detected; and
instructions for placing another VoIP emergency call to the VoIP telephones of non-emergency authority users located outside of the building who are to be notified of the emergency in response to the VoIP emergency call being placed to the VoIP telephone of the emergency authority user.

22. The medium of claim 21 further comprising:
instructions for communicating a notification to VoIP telephones of the VoIP network associated with the building for alerting users of the building to the emergency in response to the emergency being detected.
